(19) United States
(12) Patent Application Publication
(10) Pub. No.: US 2007/0268601 A1
(43) Pub. Date: Nov. 22, 2007

(54) LENS MODULE AND ASSEMBLING METHOD THEREOF

(75) Inventor: SHENG-JUNG YU, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/614,334

(22) Filed: Dec. 21, 2006

(30) Foreign Application Priority Data
May 19, 2006 (TW) 095117907

(51) Int. Cl. G02B 7/02

(52) U.S. Cl. 359/819

(57) ABSTRACT

A lens module includes a barrel, a first lens, a lens holder and a second lens. The barrel has a barrel through hole defined therein. The first lens is fixed in the barrel through hole. The lens holder has a holder through hole defined therein. The second lens is fixed in the holder through hole. The lens holder is rotatably received in the barrel through hole of the barrel, whereby the second lens is coaxially aligned with the first lens. A method for assembling the lens module is also provided.

### TECHNICAL FIELD

The present invention relates to lens modules, and more particularly to a lens module and assembling method thereof.

### BACKGROUND

With the ongoing development of microcircuitry and multimedia technology, digital cameras are now in widespread use. High-end portable electronic devices, such as mobile phones and PDAs (Personal Digital Assistants), are being developed to be increasingly multi-functional. Many of these portable electronic devices are now equipped with a digital camera. The camera generally includes a lens module. To enable high quality photos to be taken, the lens module should, most advantageously, be arranged coaxially to each other.

A typical lens module includes a housing and several lenses. The housing is substantially in the form of a hollow cylinder and has a center cavity. The lenses are received in the center cavity. However, conventionally, each of the lenses and the housing are all not adjustable. As a result, a central axis of a certain lens may diverge from that of other lenses. The quality of the image captured by these lenses tends to be correspondingly low as a result of such inclination problems.

What is needed, therefore, is a lens module that is compact and easy to assemble, and that has full co-axiality between lenses.

What is also needed is a method for assembling the above-described lens module.

### SUMMARY

A lens module and assembling method thereof according to a preferred embodiment is provided.

The lens module includes a barrel, a first lens, a lens holder and a second lens. The barrel has a barrel through hole defined therein. The first lens is fixed in the barrel through hole. The lens holder has a holder through hole defined therein. The second lens is fixed in the holder through hole. The lens holder is rotatably received in the barrel through hole of the barrel, thus coaxially aligning the second lens with the first lens.

The method for assembling the lens module includes the steps of:

(1) providing a barrel having a barrel through hole defined therein;

(2) fixing a first lens in the barrel through hole of the barrel;

(3) providing a lens holder having a holder through hole defined therein;

(4) fixing a second lens in the holder through hole of the lens holder;

(5) placing the lens holder with the second lens therein in the barrel through hole of the barrel; and

(6) rotating the lens holder relative to the barrel in a manner such that the second lens is coaxially aligned with the first lens.

### BRIEF DESCRIPTION OF THE DRAWINGS

Many aspects of the present lens module and assembling method thereof can be better understood by reference to the following description of embodiments thereof taken in conjunction with the accompanying drawings.

FIG. 1 is a schematic, cross-sectional view of a lens module in accordance with a preferred embodiment of the present invention;

FIG. 2 is a schematic, top view of the lens module in accordance with the preferred embodiment of the present invention.

The exemplifications set out herein illustrate at least one preferred embodiment of the present lens module and assembling method thereof, in one form, and such exemplifications are not to be construed as limiting the scope of the invention in any manner.

### DETAILED DESCRIPTION OF PREFERRED EMBODIMENTS

Reference will now be made to the drawings to describe in detail the preferred embodiments of the present lens module and assembling method thereof, in detail.

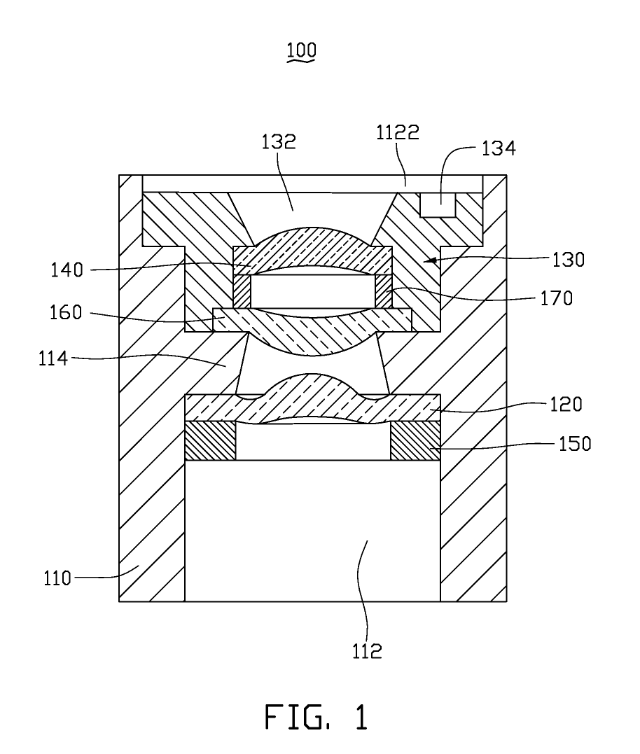

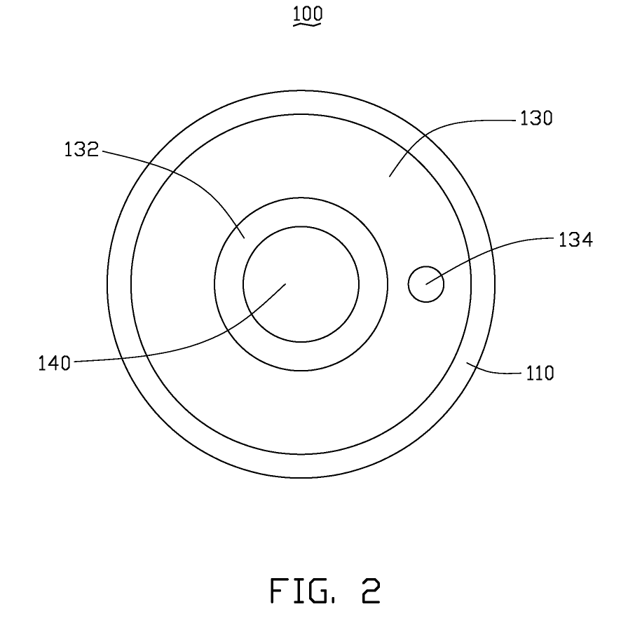

Referring to FIGS. 1 and 2, a lens module 100 mainly includes a barrel 110, a first lens 120, a lens holder 130, and a second lens 140.

The barrel 110 is a hollow cylindrical member and has a barrel through hole 112 defined therein. The barrel through hole 112 has a stepped hole portion 1122. An annular flange 114 extends inwardly from an inner wall of the barrel 110.

The first lens 120 is fixed in the barrel through hole 112. Particularly, one side of the first lens 120 contacts with a lower side of the annular flange 114. Advantageously, an auxiliary supporting ring 150 is configured (i.e., structured and arranged) for supporting the first lens 120. It can be understood that, of course, a number of the first lens 120 can be arranged in the barrel through hole 112, or at least one other lens and the at least one first lens 120 can be arranged in the barrel through hole 112, and all axes of the lenses are essentially coaxial.

The lens holder 130 has a holder through hole 132 defined therein. The lens holder 130 is rotatably and interferentially received in the barrel through hole 112 of the barrel. Preferably, the lens holder 130 is shaped so as to be received in the stepped hole portion 1122 of the barrel through hole 112. The lens holder 130 defines a recess 134 therein for allowing an operator to rotate the lens holder 130 relative to the barrel 110 using a tool. A cross section of the recess 134 can be circular or polygonal. Of course, it can be many of recesses 134 formed in the lens holder 130.

The second lens 140 is fixed in the holder through hole 132 of the lens holder 130. Particularly, one side of the second lens 140 contacts with a front-end portion of the lens holder 130. The lens holder 130 can also have a third lens 160 arranged in the holder through hole 132 of the lens holder 130. Particularly, one side of the third lens 160 contacts with a higher side of the annular flange 114. Advantageously, an auxiliary spacer 170 is arranged between the second lens 140 and the third lens 160 for supporting the second lens 140 and the third lens 160. Axes of the second lens 140 and the third lens 160 are essentially coaxial. It is understood that, of course, it can be many second lenses 140 and many third lenses 160 arranged in the holder through hole 132, and axes of the many second lenses 140 and the many third lenses 160 are all essentially coaxial.

A method for assembling the above-described lens module 100 should include the steps of:

(1) providing a barrel 110 having a barrel through hole 112 defined therein;

(2) fixing a first lens 120 in the barrel through hole 112 of the barrel 110;

(3) providing a lens holder 130 having a holder through hole 132 therein;

(4) fixing a second lens 140 in the holder through hole 132 of the lens holder 130;

(5) placing the lens holder 130 with the second lens 140 in the barrel through hole 112 of the barrel 110;

(6) rotating the lens holder 130 relative to the barrel 110 in a manner such that the second lens 140 is coaxially aligned with the first lens 120.

In the step (1), the barrel through hole 112 has a stepped hole portion 1122. An annular flange 114 extends inwardly from an inner wall of the barrel 110.

In the step (2), the first lens 120 can be fixed in the barrel through hole 112 of the barrel 110 with ultraviolet glue, transparent glue, super fast glue or resin white glue. One side of the first lens 120 contacts with a lower side of the annular flange 114, and the other opposite side of the first lens 120 is supported by an auxiliary supporting ring 150.

In the step (3), the lens holder 130 defines a recess 134 therein for allowing an operator to rotate the lens holder 130 relative to the barrel 110 using a tool. A cross-section of the recess 134 can be circular or polygonal.

In the step (4), further, a third lens 160 is provided. The third lens 160 and the second lens 140 are fixed in the holder through hole 132 with ultraviolet glue, transparent glue, super fast glue or resin white glue. Particularly, one side of the second lens 140 contacts with a front-end portion of the lens holder 130, and one side of the third lens 160 contacts with a higher side of the annular flange 114. Advantageously, an auxiliary spacer 170 is arranged between the second lens 140 and the third lens 160 for supporting the second lens 140 and the third lens 160. Axes of the second lens 140 and the third lens 160 are essentially coaxial. The second lens 140 and the third lens 160 can rotate relative to the barrel 110 along with the lens holder 130 such that the second lens 140 and the third lens 160 are coaxially aligned with the first lens 120.

In step (5), the lens holder 130 with the second lens 140 and the third lens 160 is rotatably and interferentially received in the barrel through hole 112 of the barrel. Preferably, the lens holder 130 is shaped so as to be matingly received in the stepped hole portion 1122 of the barrel through hole 112.

In the step (6), further, a tool having an engaging portion and a testing instrument are provided. Inserting the engaging portion of the tool into the recess 134, rotating the lens holder 130 relative to the barrel 110, and observing the resolution of the lens module 100 by the testing instrument. The testing instrument can be a modulation transfer function tester or a projection machine.

An advantage of the lens module 100 is that the lens holder 130 is rotatably and interferentially received in the barrel through hole 12 of the barrel 110 and it can be rotated with the second lens 140 and the third lens 160 relative to the barrel 110 such that the second lens 140 and the third lens 160 are coaxially aligned with the first lens 120. The lens module 100 is simple and compact and easy to assemble and has an optimal coaxial degree between lenses.

Another advantage of the lens module 100 is that the recess 134 is defined in the lens holder 130 and a tool having an engaging portion can be inserted into it to rotate the lens holder 130 relative to the barrel 110 conveniently. The method for assembling the lens module 100 is simple.

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Furthermore, this application is intended to cover such departures from the present disclosure as come within known or customary practice in the art to which the invention pertains and which fall within the limits of the appended claims or equivalents thereof.

What is claimed is:

1. A lens module comprising:
a barrel having a barrel through hole defined therein;
a first lens fixed in the barrel through hole;
a lens holder having a holder through hole defined therein; and
a second lens fixed in the holder through hole of the lens holder;
wherein the lens holder is rotatably received in the barrel through hole of the barrel, thus coaxially aligning the second lens with the first lens.

2. The lens module as claimed in claim 1, wherein the lens holder defines a recess therein for allowing an operator to rotate the lens holder relative to the barrel using a tool.

3. The lens module as claimed in claim 1, wherein the lens holder is interferentially received in the barrel through hole of the barrel.

4. The lens module as claimed in claim 1, wherein the barrel through hole has a stepped hole portion, the lens holder is shaped so as to be matingly received in the stepped hole portion of the barrel through hole.

5. A method for assembling a lens module, comprising the steps of:
(1) providing a barrel having a barrel through hole defined therein;
(2) fixing a first lens in the barrel through hole of the barrel;
(3) providing a lens holder having a holder through hole defined therein;
(4) fixing a second lens in the holder through hole of the lens holder;
(5) placing the lens holder with the second lens therein in the barrel through hole of the barrel; and
(6) rotating the lens holder relative to the barrel in a manner such that the second lens is coaxially aligned with the first lens.

6. The method as claimed in claim 5, wherein the lens holder defines a recess therein for allowing an operator to rotate the lens holder relative to the barrel using a tool.

7. The method as claimed in claim 6, further comprising the steps of providing a tool having an engaging portion, inserting the engaging portion of the tool into the recess of the lens holder, and rotating the lens holder relative to the barrel in a manner such that the second lens is coaxially aligned with the first lens.

8. The method as claimed in claim 5, wherein further comprising the steps of providing a testing instrument for observing a resolution of the lens module, and observing the resolution of the lens module during rotation of the lens holder relative to the barrel.

9. The method as claimed in claim 8, wherein the testing instrument is a modulation transfer function tester or a projection machine.

10. The method as claimed in claim 5, wherein the first lens is fixed in the barrel hole of the barrel using a glue selected from the group consisting of ultraviolet glue, transparent glue, super fast glue or resin white glue.

11. The method as claimed in claim 5, wherein the second lens is fixed in the holder through hole of the lens holder using a glue selected from the group consisting of ultraviolet glue, transparent glue, super fast glue or resin white glue.

12. The method as claimed in claim 5, wherein the lens holder is interferentially received in the barrel through hole of the barrel.

13. The method as claimed in claim 5, wherein the barrel through hole has a stepped hole portion, the lens holder is shaped so as to be matingly received in the stepped hole portion of the barrel through hole.
